(19) United States
(12) Patent Application Publication
(10) Pub. No.: US 2005/0086616 A1
(43) Pub. Date: Apr. 21, 2005

(54) Method for printed circuit board panelization

(76) Inventors: Jim Wang, Lake Worth, FL (US); Scott G. Potter, Coconut Creek, FL (US)

Correspondence Address: Larry G. Brown;Motorola, Inc., Law Department, 8000 West Sunrise Boulevard, Fort Lauderdale, FL, 33322, US

(21) Appl. No.: 10/686,054

(22) Filed: Oct. 15, 2003

(51) Int. Cl. G06F 17/50

(52) U.S. Cl. 716/2

(57) ABSTRACT

A method for panel optimization provides for optimal layout of printed circuit boards (302-306) on factory arrays (104), as well as the layout of arrays on panels (102). By using nesting algorithms to quickly simulate a large number of permutations, an optimal panelization solution can be quickly reached. The method includes the steps of collecting the necessary data (402), performing a panel dimension loop, an array length loop, and an array width loop. For every case, a total efficiency factor is calculated (422) to help determine the optimal layout.

### TECHNICAL FIELD

This invention relates in general to the field of electronics and more specifically to a method for optimizing printed circuit board panelization.

### BACKGROUND

A major factor in determining the cost of an individual Printed Circuit Board (PCB) is the configuration and orientation of multiple PCBs onto a factory array, and the configuration and orientation of multiple factory arrays onto a PCB panel such as a PCB vendor's panel. This process of fitting PCBs into arrays and arrays into panels is typically referred to as panelization. The factory array refers to the connected array of individual PCBs that pass through an electronic manufacturing line during electronic component placement (e.g., surface mount technology placement, etc.). The panel refers to a connected matrix of factory arrays that are built in a single sheet by a PCB vendor.

Although most electronic device manufacturers receive factory arrays from their PCB vendors, it is important to consider the vendor's panel design in any optimization efforts in order to insure that the lowest cost configuration is achieved. Efficient usage of panels leads to lower costs for the individual PCBs since less material is wasted. The goal of any PCB panelization effort is to find the optimal configuration of PCBs in arrays, and arrays in panels which maximize the overall utilization of the vendor's panels. This insures minimal wasted materials and therefore minimal costs. However, finding the optimal configuration is a non-trivial task for some of the following enumerated reasons:
1). There are multiple vendor panel sizes that need to be considered;
2). Each panel vendor has a different set of manufacturing criteria regarding mandatory border sizes (panel, array and PCB borders), array-to-array spacing and board to board spacing;
3). Boards can be oriented with either 0 to 180 degrees rotation depending on factory requirements;
4). The array size can be any size within limits specified by each electronic manufacturer; and
5). Parts placed on one board cannot overhang onto an adjacent board in order to insure manufacturability.

Historically, designing a PCB panelization solution has involved repetitively simulating many potential panelization solutions. Typically a person wanting to perform a panelization optimization has to run a different analysis for each of the possible vendor panel sizes and for each of the vendor manufacturing capability specifications. Because of all of the possible combinations, this approach can be very time consuming and the user may never achieve an optimal solution. Given the above, a need exists in the art for a method of panelization that can minimize some of the short comings found in the prior art.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a panel and its associated spacing measurements and an array located within the panel in accordance with an embodiment of the invention.

FIG. 2 shows a plurality of arrays and their associated spacing measurements in accordance with an embodiment of the invention.

FIG. 3 shows a plurality of PCBs on the array shown in FIG. 1 and their corresponding spacing measurements in accordance with an embodiment of the invention.

FIG. 4 shows a flowchart highlighting the panelization steps in accordance with an embodiment of the invention.

FIGS. 5 and 6 show a panelization Graphical User Interface (GUI) in accordance with an embodiment of the invention.

FIG. 7 shows a graphical overview of a panel optimization tool in accordance with an embodiment of the invention.

FIG. 8 shows graphically the advantages of using the panelization tool in accordance with an embodiment of the invention as compared to a prior art approach.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

In one embodiment of the present invention, a PCB panel optimization method comprises a web based software tool that finds the optimal configuration of PCBs on arrays and arrays on panels which maximizes the panel utilization while at the same time enforcing all required design specifications from both the panel vendor and product manufacturer standpoints. Although this embodiment will be discussed in relation to a web based software tool, the present invention can also be utilized in stand-alone, networked computer systems, or other hardware devices that can execute the panelization tool (panelization method).

The panelization method can be used to optimize the panel dimension and array size selections and find the optimal solution that makes the cost per PCB minimum. In other words, the selected panel and array dimensions are selected to obtain the highest panel utilization, or that achieves the highest Panel Efficiency Factor (PEF), which is defined as:
PEF=(Area of PCB*number of PCBs in Array*number of Arrays in Panel÷Area of Panel

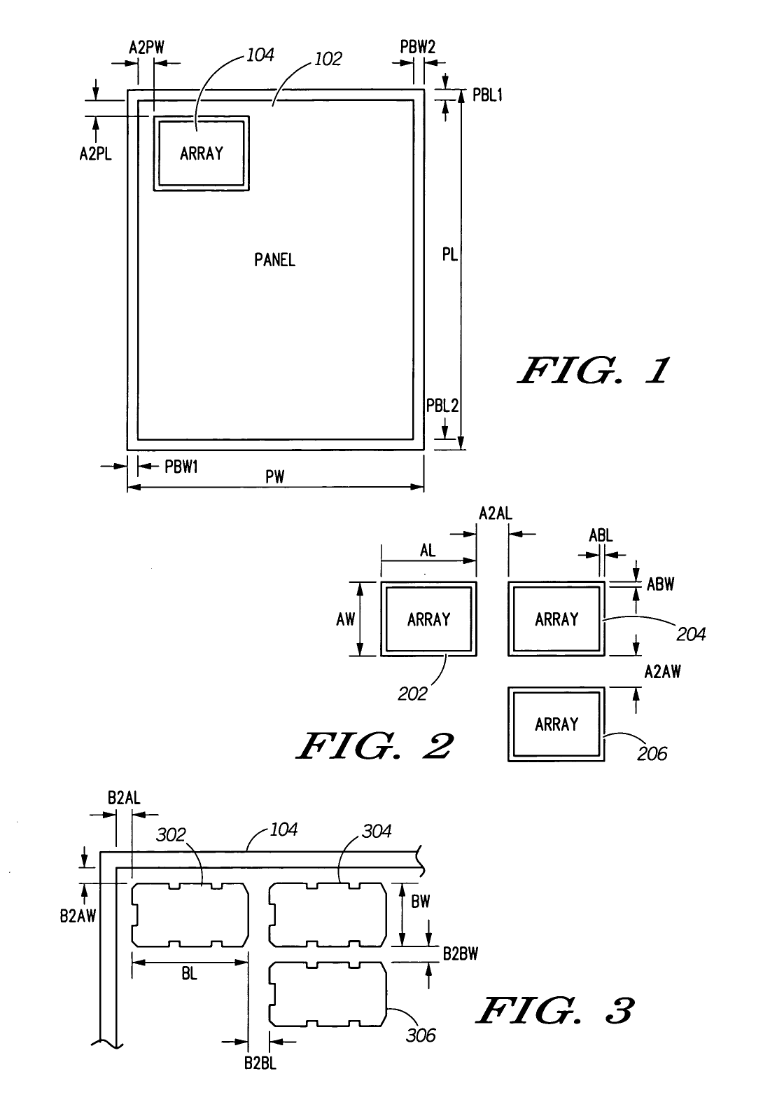

Referring now to FIG. 1, there is shown a panel 102 having an array 104 shown therein. Panel 102 has several dimensional specifications, including the Panel Length (PL), the Panel Width (PW), the Panel Border Width 1 (PBW1), the Panel Border Width 2 (PBW2), the Panel Border Length 1 (PBL1), the Panel Border Length 2 (PBL2), the Array to Panel Width (A2PW) and the Array to Panel Length (A2PL). One or more of the dimensions described are used as input information for the panelization method of the invention. Panel 102 can be manufactured from any one of a number of different materials used to manufacturer PCBs as known in the art.

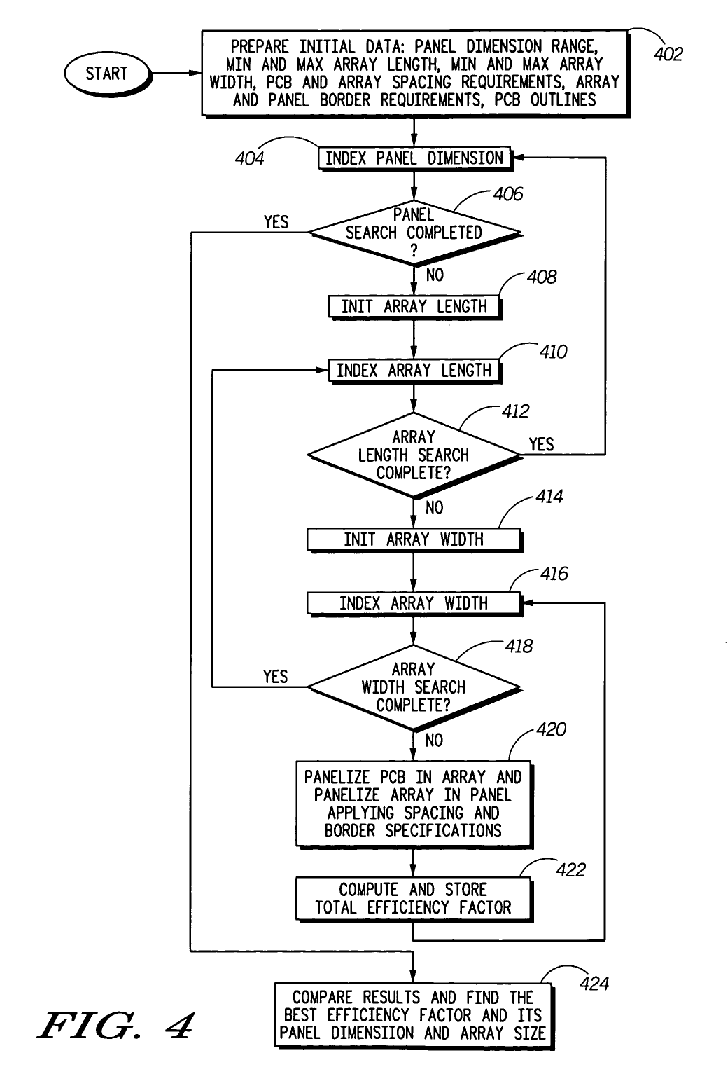

In FIG. 2, there is shown a plurality of arrays 202-206 such as those that can be found within panel 102. The array and array-to-array dimensional specifications include the Array Length (AL), the Array Width (AW), the Array to Array Length (A2AL), the Array to Array Width (A2AW), the Array Border Length (ABL), and the Array Border Width (ABW).

In FIG. 3, a plurality of PCBs 302-306 located within array 104 are shown. The PCBs and PCB-to-PCB dimensional specifications include the Board Length (BL), the Board Width (BW), the Board-to-Board Length (B2BL), the Board-to-Board Width (B2BW), the Board-to-Array Length (B2AL) and the Board-to-Array Width (B2AW).

In FIG. 4, there is shown a flowchart highlighting some of the steps for determining the optimal panelization in accordance with an embodiment of the invention. In step 402, the initial data is collected. The data collected for the analysis can include information such as the panel dimensions the user wants to consider or may be forced to use based on panel vendor constraints. Some of the other data that can be inputted can include the minimum and maximum array length and width, PCB and array spacing requirements, array and panel border requirements and PCB outline requirements. The set of potential array sizes that are simulated include every possible combination of array lengths and widths which fall within the range allowed by the manufacturer's array size specifications. The result is that the search for the optimal panelization solution typically involves over 50,000 separate panelization simulations.

Computerized linkage to PCB vendor manufacturing requirements as well as to the user's own panelization specifications can also be included in accordance with an embodiment of the invention. For example, vendor panel specifications can be downloaded from the vendor's computer system and the specifications can be used as inputs to the panelization analysis.

In step 404, the panel dimension is selected from a group of potential panel sizes, for example, those available from a particular PCB vendor. In decision step 406, the routine determines if the panel search is completed. If the panel search is not completed, the routine moves to step 408, where the array length is initialized. For example, the array length variable is cleared (e.g., set to zero). If in decision step 406, the routine determines that the panel search has been completed, the routine moves to step 424, wherein the results for all panel utilization results are compared and the one with the best efficiency factor is selected as the optimized solution. The optimization process will provide the panel dimensions and array sizes, spacing, border and all other dimensional information relating to the utilization result or results that yielded the best efficiency factor.

Alternatively, in another embodiment, the optimization routine can provide a number of utilization results (e.g., top 5 utilization results based on the efficiency factors) and their corresponding efficiency factors and dimensional information. This alternative approach would allow the person performing the utilization study to select from a number of available panalization solutions with information on their corresponding efficiency factors. It may be that a person may be willing to give up a bit of efficiency for some reason, and this multiple solution approach would allow the user to make such a cost-benefit analysis.

In step 410, the array length is indexed or increased by a predetermined amount, and in decision step 412 it is determined if the array length search is complete. Decision step 412 may determine that the array length search is complete, if for example, the maximum array length is reached. If the array length search is not complete, the process moves to step 414 wherein the array width is initialized (array width variable cleared). If in step 412, it is determined that the array length search is complete, the routine returns to step 404. In step 416, the array width is indexed or increased by a predetermined amount.

In decision step 418, it is determined if the array width search is complete, for example by determining if the array width dimension has been increased to the maximum array width previously entered as an input in step 402. If in step 418, it is determined that the array width search is complete (maximum width reached) the routine moves back to step 410 where the array length is indexed or increased by a predetermined amount. If the array width search is determined not to be complete, in step 420, the PCB is panelized in an array and the array is panelized in the panel applying the spacing and border specifications. In step 422, the total efficiency factor for a particular array width and length is computed and stored. After step 422, the routine loops back to step 416 wherein the array width is indexed or increased in value by a predetermined amount (e.g., one millimeter, etc.).

If in step 406 it is determined that the panel search is completed, the routine moves to step 424, wherein the results are compared and the best panel efficiency factor is determined and its panel dimension and optimized array size and spacing information results are provided.

The optimal panel search algorithm discussed in relation to FIG. 4 includes a first loop or panel dimension loop where the routine goes through every possible panel dimension specified by the PCB vendor(s). A second loop or array length loop applies the minimum/maximum array length constraints by manufacturing requirements and every possible array length is analyzed. In the third loop or array width loop, minimum/maximum array width constraints by manufacturing requirements and every possible array width are analyzed.

For every selected panel dimension and array size, as many as possible arrays are populated on the panel while applying the array spacing and panel border specifications provided. For every selected array size, as many as possible PCBs are populated on the array while applying PCB spacing and array border specifications provided. The total panel efficiency factor or cost per PCB is determined for every case and all of the above results are compared and the best solution or solutions are selected and reported to the user. The best solution has the highest total efficiency factor or lowest cost per PCB. The dimensions of the optimal panel and array sizes are reported to the user. Also, the layouts of the optimal arrays on the optimal panel and the layout of PCBs on the optimal array are generated.

In one embodiment of the invention, the ability to execute many panelization simulations is enabled by using a high speed rectangle nesting algorithm. In cases where complex polygon nesting is employed, the nested board set is modeled by its bounding rectangle in order to employ the high speed rectangle nesting algorithm. This approach enables true board outline polygon nesting (typically a much slower calculation) while still allowing for the use of the high speed nesting approach in order to find the optimal panelizaiton solution within a reasonable period of time (e.g., 4 minutes).

In a typical panelization optimization using the method described herein, it is not uncommon to perform 50,000 panelization simulations, with the panel utilization results calculated and saved for later analysis. Preferably, the PCB outline description is imported using Computer Aided Design (CAD) files and non-overhanging parts located on the PCB are filtered out prior to commencing the optimization analysis.

Once all simulations are completed, the solution set is complete and ready to be used to find the optimal solution, as well as perform sensitivity analysis solutions that may provide superior results. For example, the routine may inform the person performing the analysis that if the panel could be increased by a certain amount, the efficiency factor could be increased by a predetermined amount more. It would be then up to the person performing the analysis if it is worthwhile to make such an adjustment.

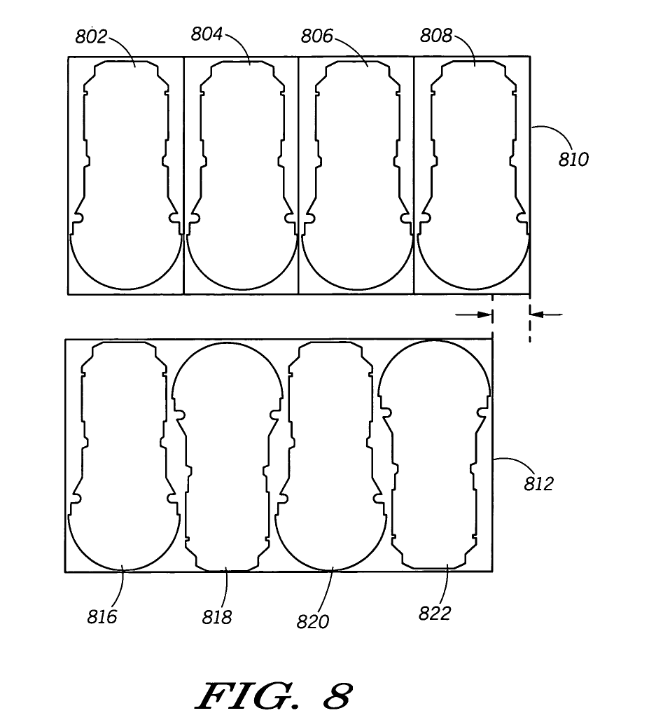

On occasions, there may be cases where multiple solutions yield the same panel utilization results (e.g., have equal efficiency factors), in these cases, while all of the optimal solutions are provided to the user in order for a choice to be made, the typically recommended optimal solution is the solution which yields the highest panel utilization while at the same time maintaining the largest array size. This is the preferred solution since it gives the PCB designer the most flexibility for adding larger support ribs on the factory array and for adapting to potential board size increases in later design revisions. A graphical drawing (see for example item 812 in FIG. 8) of the optimal solution can also be presented to the user along with the panel utilization metrics and panel and array dimensions.

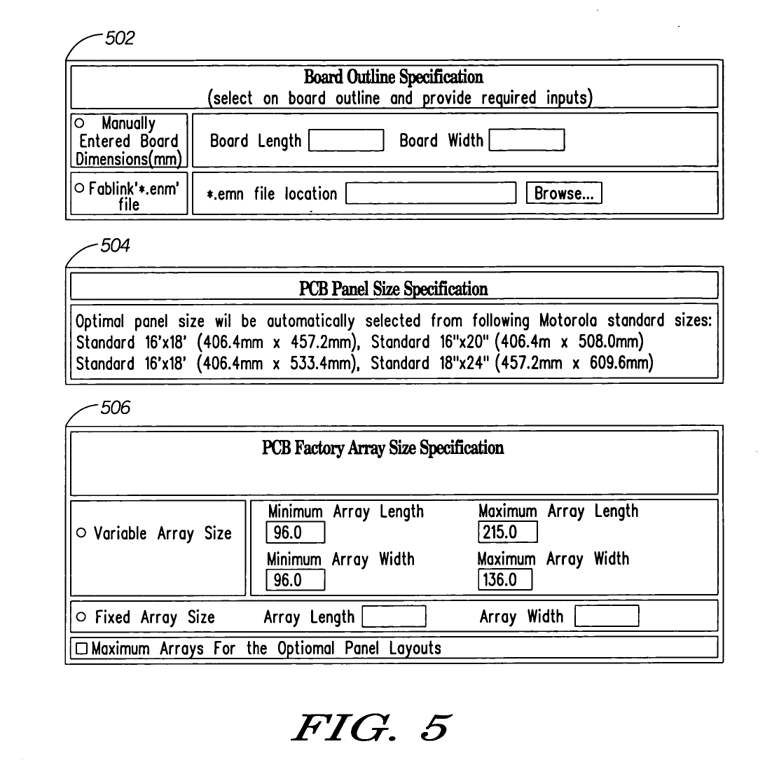

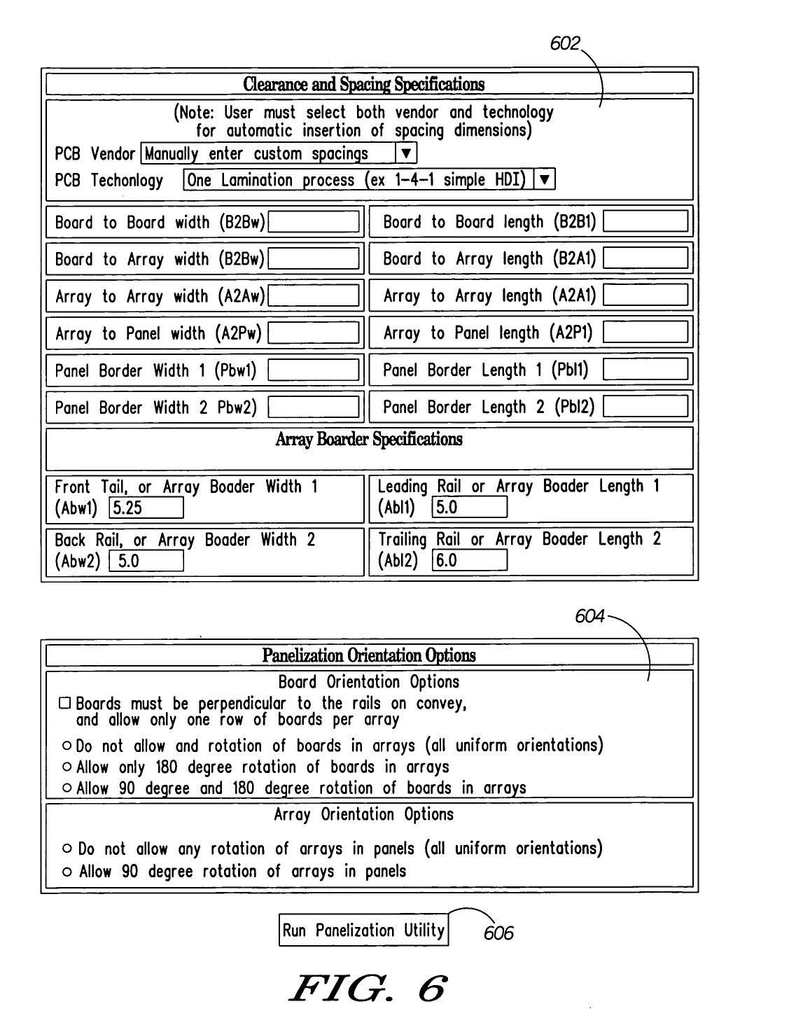

The dimensional specifications mentioned above and other specifications that can be selected as inputs to the panelization algorithm can be entered using a Graphical User Interface (GUI) such as that shown in FIGS. 5 and 6. In FIG. 5, the first input block is the board outline specification block 502 which allows a user to manually enter the Board Length and Board Width, or import a board outline file (“.emn file”, etc. generated using design software such as ProE, etc.), in order to execute panelization simulations based on the complex polygon that defines the board outline.

The next input block is the PCB panel size specification block 504 which highlights the different panel sizes the result will be selected from. The next block in the GUI is the PCB factory array size specification block 506, which lets the user select a fixed array size having a predetermined length and width, or allow the user to have the panelization software make an optimization determination using maximum and minimum information for both the array length and the array width. The user can also select if he/she wants the panelization algorithm to determine the maximum arrays that can be placed in a panel for optimal layout.

In FIG. 6, the GUI blocks continue with the clearance and spacing specifications and array border specification inputs. The panelization software allows the user to enter a particular PCB vendor he wants to use and a particular PCB technology that the user wants to be used. The vendor and technology inputs in block 602 may limit the different sizes of panels that will be analyzed in the optimization as well as dimensions that can be used. In block 602, the user can enter information regarding the numerous specifications regarding the boards, arrays and borders. In block 604, the user can also enter panelization orientation options such as allowing for 90 degree rotation and 180 degree rotation of boards in arrays, or not allowing for any array rotation. Once all of the specifications have been entered, the user clicks on the “Run Panelization Utility” button 606 to commence the panelization optimization routine.

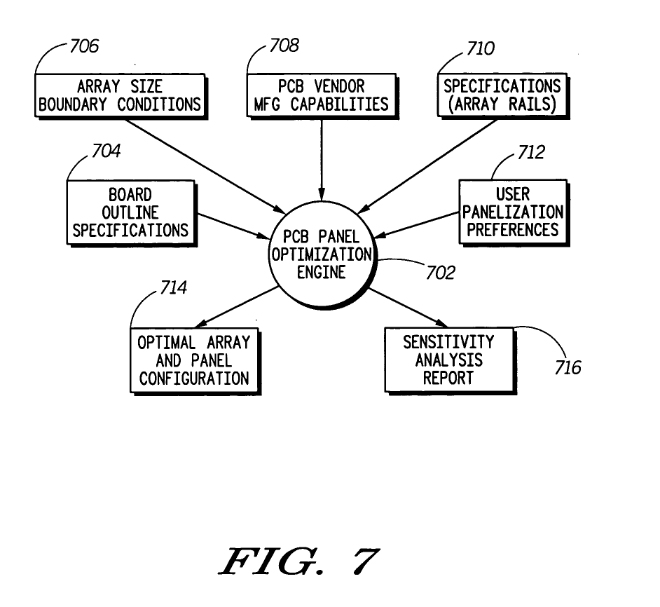

In FIG. 7, there is shown an overview of the inputs and outputs to the PCB panel optimization engine 702. The inputs to the optimization engine 702 include PCB outline specifications 704, array size boundary conditions 706, linkage to PCB vendor manufacturing requirements 708, manufacturer specifications for the array 710 and user selectable panelization preferences 712. The inputs are processed by the PCB panel optimization engine which generates a report that includes the optimal array and panel configuration information 714 as well as a sensitivity analysis report 716.

Referring now to FIG. 8, there is shown a graphical representation of an illustrative example of an area reduction that can be achieved when boards 816-822 are modeled by their true board outlines 812 in accordance with an embodiment of the invention, as compared to the prior art approach of using a bounding rectangle to represent each board, as represented by boards 802-808 in array 810. As shown, the array 810 which represents each PCB as a rectangle requires a longer array, than the array 812 which uses the panelization technique of the present invention. The savings in array length 814, translates into a lower cost PCB since each array is smaller, and correspondingly each panel used can carry more arrays or a smaller panel can be used.

A unique feature of the panelization routine is its ability to import a component file generated by a board layout software tool in order to include any components that are overhanging from the board outline into the simulation. The optimization routine can analyze all parts in the bill of materials for a particular PCB in order to include any components that are overhanging from the board outline into the simulation. Simulations have shown that the panel optimization routine leads to an approximately 5% to 10% improvement in panel utilization which translates into a 5-10% reduction in PCB cost.

While the preferred embodiments of the invention have been illustrated and described, it will be clear that the invention is not so limited. Numerous modifications, changes, variations, substitutions and equivalents will occur to those skilled in the art without departing from the present invention as defined by the appended claims.

1. A method for performing Printed Circuit Board (PCB) panel optimization, comprising the steps of:
performing a panel dimension loop that goes through a plurality of possible panel dimensions;
performing an array length loop that goes through a plurality of array lengths;
performing an array width loop that goes through a plurality of array widths; and
calculating a panel efficiency factor for each iteration of each of the loops in order to determine a panel layout.

2. A method as defined in claim 1, further comprising the step of:
preparing initial data regarding panel dimension range, minimum and maximum array length and minimum and maximum array width.

3. A method as defined in claim 2, wherein the initial data is used to limit the amount of iterations that are performed by the panel dimension loop, the array length loop and the array width loop.

4. A method as defined in claim 2, wherein the step of preparing the initial data further comprises preparing initial data on PCB and array spacing requirements, array and panel border requirements and PCB outlines.

5. A method as defined in claim 1, wherein for each iteration of the panel dimension loop as many arrays are fitted onto the panel as possible.

6. A method as defined in claim 1, further comprising the step of:
applying array spacing and panel border specification requirements.

7. A method as defined in claim 6, further comprising the steps of:
comparing the panel efficiency factors for each iteration; and
selecting the highest panel efficiency factor and using its corresponding panel dimension and array size for the panel layout.

8. A method as defined in claim 7, further comprising the step of:
performing a sensitivity analysis in which outputs can be provided regarding possible changes to any one or more of the panel dimensions, array size, array spacing and panel border specification requirements.

9. A method as defined in claim 2, wherein the step of preparing the initial data comprises inputting data using a web based graphical user interface.

10. A method as defined in claim 9, wherein the step of preparing the initial data further comprises importing an outline file of a PCB that is to be fitted into the arrays and panel.

11. A method as defined in claim 10, wherein the outline file of the PCB provides information on a complex polygon that defines the PCB that is to be fitted into the arrays.

12. A method for optimizing the fitting of Printed Circuit Boards (PCBs) onto at least one array and the at least one array onto a PCB panel, the method comprises the steps of:
loading information regarding the outline of the PCBs;
performing multiple iterations regarding different potential dimensions for the panel and the at least one array; and
determining a Panel Efficiency Factor (PEF) for each iteration in order to determine the array and panel dimensions to use for the particular PCB outline.

13. A method as defined in claim 12, wherein the information regarding the outline of the PCBs is automatically imported from a design file which provides information on a complex polygon that defines the PCB outline.

14. A method as defined in claim 12, further comprising the steps of:
inputting information regarding panel dimensions that can be used and the minimum and maximum array length and width that can be used; and
using the information inputted to determine the array and panel dimensions.

15. A method as defined in claim 14, wherein in the inputting step, information regarding PCB and array spacing requirements and array and panel border requirements are also inputted and used to determine the array and panel dimensions.

16. A method as defined in claim 15, wherein in the inputting step, information regarding whether the PCBs can be rotated in the at least one array during the fitting of the PCBs onto the at least one array is entered.

17. A method as defined in claim 12, wherein the array and panel dimensions are determined by selecting the array and panel dimension combination that provides for the highest PEF.

18. A method as defined in claim 17, wherein the method is performed using a web based software tool that includes a graphical user interface.

19. A method as defined in claim 17, wherein if more than one array and panel dimensions yields the highest PEF, the one having the largest array size is selected as the panelization solution.
